(19) United States
(12) Patent Application Publication
(10) Pub. No.: US 2011/0099439 A1
(43) Pub. Date: Apr. 28, 2011

(54) AUTOMATIC DIVERSE SOFTWARE GENERATION FOR USE IN HIGH INTEGRITY SYSTEMS

(75) Inventors: Simon Brewerton, Trowbridge (GB); Pawel Jewstafjew, Bradley Stoke (GB)

(73) Assignee: Infineon Technologies AG, Neubiberg (DE)

(21) Appl. No.: 12/605,139

(22) Filed: Oct. 23, 2009

(51) Int. Cl. G06F 11/07; G06F 9/44; G06F 1/02

(52) U.S. Cl. 714/724; 717/106; 708/270; 717/140; 714/E11.024

(57) ABSTRACT

Systems, devices and methods of automatic diverse software generation are disclosed. In an embodiment, a method includes providing a base algorithm implementation related to a first hardware profile of a hardware resource, automatically generating a diverse algorithm implementation related to a second hardware profile different from the first hardware profile using the base algorithm implementation and information about the hardware resource, and executing the base algorithm implementation and the diverse algorithm implementation. Embodiments of systems and devices, including microprocessors and compilers, are also disclosed.

### TECHNICAL FIELD

The invention relates generally to software and, more particularly, to software that can be used to confirm the accuracy of individual algorithm computations and has applicability in safety critical or high integrity systems.

### BACKGROUND

High integrity software has become commonplace in a variety of wide-ranging applications. For example, many automotive, banking, aerospace, defense, Internet payment, and other applications have critical paths that require validation of safe operation by means of redundancy, diversity or both.

The general approach of guaranteeing safe operation of a critical path is for two algorithms to be computed and the results compared for consistency or plausibility using an independent comparator. Generally, this has been implemented via two different methods. First, on a system with more than one processing channel, identical algorithms can be computed simultaneously, with one algorithm processed on its own processing channel, and the results compared for consistency. Second, on a system that is limited to one active processing channel, two (or more) diverse algorithms can be computed with temporal separation. These results are then cross-checked for consistency or plausibility.

Problems exist for both of these implementations. One key problem with the two (or more) diverse algorithms computed on a single channel implementation is the need to prove for any generic case that the algorithm diversity really has an absolute level of immunity to common cause failures. These failures are both in the hardware that executes the software and in the tooling that generates the software. Also, the developer is forced to build several diverse algorithms and define suitable pass limits for the respective sets of results for these algorithms, as well as prove that they are valid. Additionally, detailed studies must be undertaken to ascertain the independence of the actual implementations of the algorithms such that safety accreditation can be assessed, specifically for common cause and single point failures of the single processing channel. Often a simulation of the algorithms must be performed to show suitable diagnostic coverage. Further, the use of high-level languages to define the operation of the algorithm in a target system relies on “rules” of generating the low-level operational embedded software, such that diversity in the high-level representation is diminished or eliminated when processed in the target processing channel. A problem in both the method of a single algorithm processed on two redundant processing channels and the method of two (or more) diverse algorithms computed on a single processing channel with temporal separation is the need to claim an independence of the processed algorithms from significant common cause failures.

### SUMMARY OF THE INVENTION

Embodiments relate to systems, devices and methods of automatic diverse software generation. In an embodiment, a method comprises providing a base algorithm implementation related to a first hardware profile of a hardware resource, automatically generating a diverse algorithm implementation related to a second hardware profile different from the first hardware profile using the base algorithm implementation and information about the hardware resource, and executing the base algorithm implementation and the diverse algorithm implementation.

In an embodiment, a system comprises a first algorithm generator to generate a first algorithm defining a first hardware base and a first series of operations to be executed by the first hardware base, and a second algorithm generator configured to generate a second algorithm using the first algorithm and a hardware profile, the second algorithm defining a second hardware base and a second series of operations to be executed by the second hardware base, at least one of the sets of the first and second hardware bases and the first and second series of operations being diverse.

In an embodiment, a compiler comprises an algorithm generator configured to receive as input a first algorithm and target hardware knowledge and to automatically generate therefrom a second algorithm defining a different hardware allocation and a different sequence of operations than the first algorithm.

In an embodiment, a microprocessor comprises a processor comprising logic, a first subset of the logic comprising a first logic cloud and a second subset of the logic comprising a second logic cloud, and a program memory comprising a base algorithm relating to the first logic cloud and a diverse algorithm generated from the base algorithm and information about the logic and relating to the second logic cloud.

In an embodiment, a method comprises manually creating a base algorithm implementation associated with a first hardware channel of an array of hardware channels; automatically generating a diverse algorithm implementation associated with a second hardware channel of the array of hardware channels using the base algorithm implementation; and executing the base algorithm implementation and the diverse algorithm implementation using the first hardware channel and the second hardware channel, respectively.

### BRIEF DESCRIPTION OF THE DRAWINGS

The invention may be more completely understood in consideration of the following detailed description of various embodiments of the invention in connection with the accompanying drawings, in which:

FIG. 1 depicts a block diagram of an automated diverse algorithm generator according to an embodiment.

FIG. 2 depicts a block diagram of an automated diverse algorithm generator according to an embodiment.

FIG. 3 depicts a block diagram of shared processing resources utilized by an embodiment of an automated diverse algorithm generator.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Systems and methods relating to an automated process for generating diverse implementations of an algorithm from a base algorithm are disclosed. In an embodiment, an automated process or compiler-type reduction takes a base algorithm and generates a second, diverse implementation using detailed knowledge of the target processing channel. The process performs an examination of the base algorithm and resources required to process the base algorithm in the targeted processing channel and then builds a new algorithm which diversifies the common processing channel resources between the two implementations. The process further reduces common cause failures by additionally applying transformation techniques to the algorithm structure and data representation. This analysis and subsequent reordering, translation, and diverse mapping provides both temporal and logical diversity between the new algorithm and the base algorithm.

Because the developer utilizes a single base algorithm, additional distinct algorithms need not be built. Similarly, the developer does not need to define pass limits or acceptable sets of results for numerous algorithms. The quality of diversity is thus independent of the developer as the quality is in this embodiment a function of the automated process rather than the skill of the programmer. Further, because the process is implemented at a high level by a compiler-type process with knowledge of the processing sub-systems to be tested, the problem of decreased diversity as a result of “rules” generating the low-level software is eliminated. The solution also removes the burden of proof from the developer to show that the algorithms implemented have achieved suitable diversity. Instead, a single set of test cases can prove the base algorithm is operating correctly with the requisite level of diversity.

In another embodiment, the base algorithm is one level removed, and two algorithm generators having knowledge of the hardware and software resources required by the other generate a base implementation and a diverse implementation, respectively.

In another embodiment, the base algorithm is one level removed, and N algorithm generators having knowledge of the hardware and software resources required by the other N generators generate a base implementation and N diverse implementations, respectively. Thus, depending on the level of diagnostic coverage desired, embodiments are infinitely scalable, limited only by the resources of the target hardware.

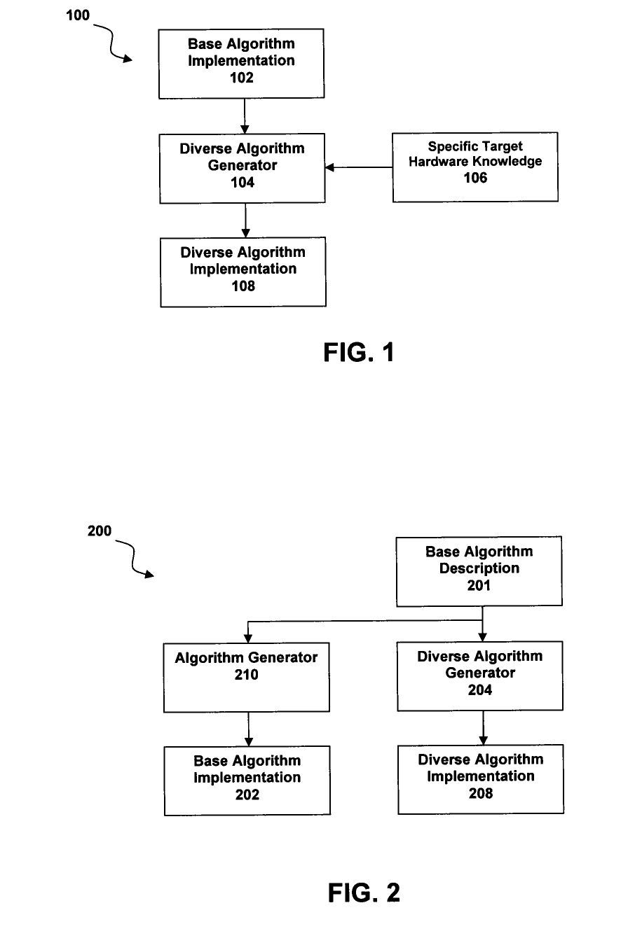

FIG. 1 illustrates generally a block diagram of one example of an automated process for diverse algorithm implementation 100. As a starting point for diverse algorithm implementation 100, base algorithm implementation 102 is presented. Base algorithm 102 may be any algorithm or section of code deemed safety-critical, or any algorithm or section of code a developer wishes to ensure is calculated correctly. In an embodiment, base algorithm 102 is written, assembled or otherwise created by a developer.

A diverse algorithm generator 104 can be embedded into the normal compilation toolchain used to generate low level machine code from the high level language description. In an embodiment, the high level language description is C code. In other embodiments, other languages and/or coding techniques and descriptors are used. Implementation of diverse algorithm generator 104 into the compiler provides, for example, a reduced generation effort as a static and dynamic allocation of predefined diverse resources could already be made. Diverse algorithm generator 104 utilizes base algorithm implementation 102 as an input.

Base algorithm implementation 102 is an algorithm running or to be run on a processing channel that uses some combination of hardware and software and, in an embodiment, is the only base algorithm that a developer need build.

Diverse algorithm generator 104 can also use specific target hardware knowledge 106 as an input. In an embodiment, target hardware knowledge 106 includes one or more of information regarding a required hardware base and/or compilation; information regarding available hardware, including “clouds” of hardware; information regarding sets of hardware substitutions and options available; information regarding hardware capabilities and specifications; and other knowledge.

A presupposition, however, is that base algorithm 102 does not use every possible combination of available hardware resources available in the processing channel. Thus, diverse algorithm generator 104 is configured to automatically generate a different sequence of operations, algorithm representation, storage and representation of data, and/or required hardware base to execute the algorithms, thereby generating a diverse algorithm implementation 108 without need for developer programming. Diverse algorithm implementation 108, as the output of diverse algorithm generator 104 using inputs base algorithm implementation 102 and specific target hardware knowledge 106, is a substantially different instance of base algorithm implementation 102. Data can be run through base algorithm implementation 102 and diverse algorithm implementation 108 and compared for consistency or accuracy. In embodiments, the types and degrees of differences between base algorithm implementation 102 and diverse algorithm implementation 108 vary. The reordering and translation and mapping of the operations by diverse algorithm generator 104 allows much higher diagnostic coverage of single point failures that fall within the shared resources as the final output, diverse algorithm implementation 108, will have a substantially different failure than base algorithm implementation 102.

In an embodiment, and with base algorithm implementation 102 and target hardware knowledge 106 as input, diverse algorithm generator 104 processes base algorithm implementation 102 and target hardware knowledge 106 and generates a new algorithm utilizing a different hardware base and sequence of operations to execute. For example, diverse algorithm generator 104 performs an examination of base algorithm implementation 102, including the resources required to process the base algorithm itself in the targeted processing channel, of which generator 104 is aware via targeted knowledge 106, in an embodiment. Diverse algorithm generator then builds a new algorithm (108) that minimizes, or diversifies, the common processing channel resources and reduces common cause failures by additionally applying transformation techniques to the algorithm structure and data representation to guarantee both temporal and logical diversity between the new algorithm (108) and the base algorithm (102) when executed. The diversity of hardware utilization between base algorithm 102 and diverse algorithm 108 to run the mathematically equivalent operations of the two algorithms 102, 108 greatly increases the diagnostic coverage of faults in the hardware base for both unique and common hardware parts.

In another embodiment, base algorithm 102 and diverse algorithm 108 are configured to execute on distinct ones of channels in an array of available of channels. For example, available hardware can comprise an array of available processing channels. From a base algorithm 102, at least one diverse algorithm 108 can be generated, and base algorithm 102 and diverse algorithm 108 can be run on different processing channels to provide robustness against common cause failures, including when the different processing channels are multiple instances of the same type of hardware or processing channels.

Advantageously, automatic generation of diverse algorithm 108 does not require modification to the development process for a typical user/developer, as diverse algorithm generator 104 is configured to automatically take a basic algorithm (102) and map the algorithm into two implementations. Embodiments also remove the burden of proof from the developer to show that suitable diversity has been achieved, as diverse algorithm generator 104 can be shown to always perform this function under a suite of suitable test cases.

As previously mentioned, diverse algorithm generator 104 can be embedded into the normal compilation toolchain used to generate low level machine code from the high level language description. Implementation of diverse algorithm generator 104 into the compiler provides, for example, a reduced generation effort as a static and dynamic allocation of predefined diverse resources could already be made. Techniques that can be used are based on modification of customary compiler backend such that a hierarchy of hardware usage and pipeline scheduling is made intentionally diverse. This includes, for example, typical compiler switches that perform different levels of optimization and controlling the output of the compiler. Various exemplary and non-limiting techniques which can be utilized singularly or in various combinations are described below.

For example, diverse algorithm generator 104 using specific target hardware knowledge 106 can utilize register allocation. This can include altering the relative priority the compiler would use to assign the actual registers of the hardware, changing the assumed programming model of the hardware where certain registers are assumed to always have the same meaning, and reserving sets of registers for each algorithm implementation in embodiments.

Diverse algorithm generator 104 using specific target hardware knowledge 106 can also utilize instruction scheduling. This can include using different instruction combinations between the algorithm implementations, reordering instructions such that pipeline conflicts are resolved in another manner, and reserving some of the available instruction from one algorithm generator in embodiments.

Another technique diverse algorithm generator 104 using specific target hardware knowledge 106 can also utilize input data address translation, output data address translation, or both. This can include mapping one set of algorithm input data into multiple unique address spaces, mapping one set of output data into multiple unique address spaces, or mapping both input and output data into multiple unique address spaces.

Diverse algorithm generator 104 using specific target hardware knowledge 106 can additionally utilize machine context duplication. This may include using a stack-based processing model in lieu of register-based one, or a register-based processing model in lieu of a stack-based one.

Diverse algorithm generator 104 using specific target hardware knowledge 106 can also utilize different optimization techniques for loops and/or conditional operations. Diverse algorithm generator 104 can also vary data representation, such as representing data in different number representations (e.g., fixed point and floating point).

Use of co-processors and/or accelerators can also be available to diverse algorithm generator 104 in embodiments. These can include, for example, other arithmetic logic units, digital signal processing engines and/or floating point units.

Another technique that can be utilized by diverse algorithm generator 104 is variation of data structure addressing. This can include structure order inversion and packing to assure minimum common addressing.

Data binary encoding can also be utilized by diverse algorithm generator 104. In embodiments, this can include one or more of gray code, bit inversion, width and alignment adjustment, big- and little-endianness and one's complement arithmetic.

Diverse algorithm generator 104 can also transform an algorithm to another representation. This technique can utilize Laplace transforms, polar transforms and Fourier transforms, for example.

A different precedence of expression evaluation can also be utilized by diverse algorithm generator 104. For example, (A*B*C) can instead be ((A*B)*C) or (A*(B*C)). Reverse Polish notation and/or DeMorgan mapping are additional techniques that can be utilized by diverse algorithm generator 104.

Diverse algorithm generator 104 can also utilize different auxiliary libraries and tool sets and different internal compiler interim code. The latter can include modification of the compiler front end to use a different implementation of internal storage. Diverse algorithm generator 104 can also utilize different internal operational code representations of required logical functions. This can be done, for example, by using operational codes that have different addressing modes or representations in the binary image of the algorithm.

Utilization of one or more of these and other techniques along with specific target hardware knowledge 106 enables diverse algorithm generator 104 to transform input base algorithm implementation 102 into diverse algorithm implementation 108. In use, the mathematically equivalent but hardware-diverse base algorithm implementation 102 and diverse algorithm implementation 102 can be executed and the results analyzed. Proper operation of diverse generator 104 can be shown in a variety of ways, including: execution of generation process 100 over many test cases, including benchmarks and specific application code; failure injection into the processing channels (actual hardware and/or simulations) and performing a difference check of computed outputs of each algorithm to show coverage; comparison of required hardware needed to execute each algorithm, for example by hardware register transfer level (RTL) trace and code coverage comparisons; and examination of the achieved diversity for a frequently used set of basic elements of the algorithm description language or high level language toolset, for example all allowed MISRA (Motor Industry Software Reliability Association) subsets of C code, the toolbox used in MATLAB.

FIG. 2 depicts another embodiment of an automated process 200 for generating diverse implementations of an algorithm from a base algorithm. Similar to process 100, a base algorithm description 201 is input to a diverse algorithm generator 204 which generates diverse algorithm implementation 208. In process 200, however, base algorithm description 201 is a basic higher level description such that an algorithm generator 210 also generates a base algorithm implementation 202 from the same base algorithm description 201 used by diverse algorithm generator 204. In an embodiment, each of algorithm generator 210 and diverse algorithm implementation 204 have knowledge of the resources required by the other, and the split of resources can be performed statically or dynamically.

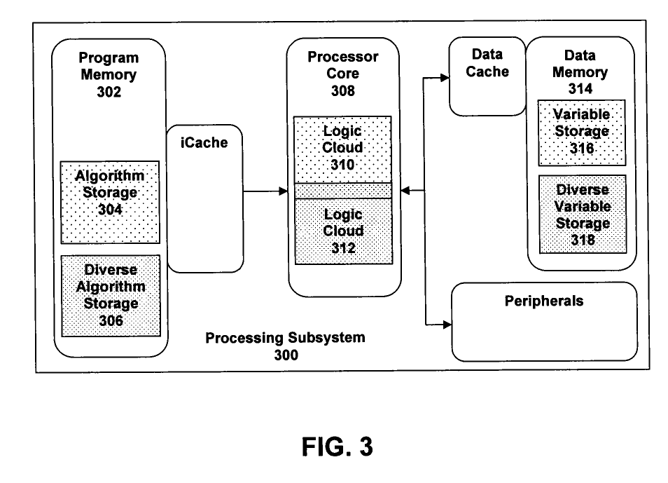

FIG. 3 is a block diagram of a processing subsystem 300 according to an embodiment. Subsystem 300 utilizes shared processing resources to implement and execute base algorithm implementation 102/202 and diverse algorithm implementation 108/208 disclosed above. Subsystem 300 includes a program memory 302 which stores base algorithm 102/202 in an algorithm storage portion 304 and diverse algorithm implementation 108/208 in a diverse algorithm storage portion 306. A processor core 308 of subsystem 300 includes a first logic cloud 310 associated with base algorithm implementation 102/202 and algorithm storage 304. Processor core 308 also includes a second logic cloud 312 associated with diverse algorithm implementation 108/208 and diverse algorithm storage 306. A data memory 314 includes a variable storage portion 316 associated with base algorithm implementation 102/202, algorithm storage 304 and logic cloud 310, and a diverse variable storage portion 318 associated with diverse algorithm implementation 108/208, diverse algorithm storage 306 and logic cloud 312.

Additional resources and process modifications are therefore not necessary to implement embodiments of the invention, from multiple perspectives. First, the varying algorithm implementations can share processing resources, not requiring additional hardware or other resources to carry out. Second, and as previously mentioned, embodiments of automatic diverse algorithm generation processes do not necessitate modification of the development process for a developer and are not developer-dependent from a quality of diversity perspective.

Embodiments disclosed herein above generally include two algorithm implementations, the base algorithm and a diverse algorithm. In other embodiments, more than two implementations can be executed. For example, multiple redundancies can have applicability to chemical reaction processes and the like, which can use an array of processing channels as described herein above.

Embodiments of automatic diverse software generation thereby provide both hardware and temporal diversity, thereby increasing diagnostic coverage of faults and providing a higher level of immunity to common cause failures. Automatically transforming a developer-coded algorithm additionally provides advantages by not altering a development process and removing developer skill from the measure of diversity quality.

In an embodiment, the base algorithm and/or the diverse algorithm comprise code operating on a computer and/or recorded on a machine-readable medium. In an embodiment, the base algorithm implementation and/or the diverse algorithm implementation comprise machine-readable code executable by a computer. In an embodiment, each of the base algorithm implementation and the diverse algorithm implementation defines a hardware base, resource or profile used to implement algorithm operations. The hardware bases can include computers, computer devices, processors, processing devices, peripherals, application-specific system hardware (e.g., hardware relating to applications including but not limited to automotive, banking, aerospace, defense, Internet payment, power generation and utilities, chemical processing and reactions, healthcare, transportation, security, HVAC and others) and other devices, systems and subsystems.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various implementations have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A method comprising:
providing a base algorithm implementation related to a first hardware profile of a hardware resource;
automatically generating a diverse algorithm implementation related to a second hardware profile different from the first hardware profile using the base algorithm implementation and information about the hardware resource; and
executing the base algorithm implementation and the diverse algorithm implementation.

2. The method of claim 1, comprising comparing a result of executing the base algorithm implementation with a result of executing the diverse algorithm implementation.

3. The method of claim 1, wherein providing a base algorithm implementation comprises manually building the base algorithm implementation.

4. The method of claim 1, wherein the hardware resource comprises a processing channel.

5. The method of claim 4, wherein the first hardware profile comprises a combination of resources available in the processing channel and the second hardware profile comprises an alternate combination of resources available in the processing channel.

6. The method of claim 4, wherein the base algorithm implementation comprises a sequence of operations and the diverse algorithm implementation comprises an alternate sequence of operations.

7. The method of claim 1, wherein automatically generating a diverse algorithm implementation is carried out by a compiler.

8. The method of claim 7, wherein the compiler comprises code on a machine-readable medium executable by a computer device.

9. A system comprising:
a first algorithm generator to generate a first algorithm defining a first hardware base and a first series of operations to be executed by the first hardware base; and
a second algorithm generator configured to generate a second algorithm using the first algorithm and a hardware profile, the second algorithm defining a second hardware base and a second series of operations to be executed by the second hardware base, at least one of the sets of the first and second hardware bases and the first and second series of operations being diverse.

10. The system of claim 9, wherein the first and second hardware bases are subsets of a hardware resource, and wherein the hardware profile comprises information about the hardware resource.

11. The system of claim 10, wherein the first and second hardware bases each comprise a hierarchy of usage of at least a portion of the hardware resource.

12. The system of claim 9, wherein the first and second algorithms each comprise pipeline scheduling.

13. The system of claim 9, wherein the second algorithm generator is implemented in a compiler.

14. The system of claim 9, wherein both of the sets of the first and second hardware bases and the first and second series of operations are diverse.

15. A compiler comprising:
an algorithm generator configured to receive as input a first algorithm and target hardware knowledge and to automatically generate therefrom a second algorithm defining a different hardware allocation and a different sequence of operations than the first algorithm.

16. The compiler of claim 15, wherein the algorithm generator comprises a set of machine-executable code.

17. The compiler of claim 15, wherein the first and second algorithms are mathematically equivalent.

18. The compiler of claim 15, further comprising a second algorithm generator configured to generate the first algorithm.

19. The compiler of claim 15, comprising a modified compiler backend configured to implement at least one diversification technique selected from the group consisting of: register allocation; instruction scheduling; input data address translation; output data address translation; machine context duplication; loop optimization techniques; conditional operation techniques; data representation; coprocessor usage; accelerator usage; data structure addressing; data binary encoding; Laplace algorithm transformation; polar algorithm transformation; Fourier algorithm transformation; precedence of expression evaluation variation; use of varying auxiliary libraries; use of varying tool sets; use of varying internal compiler interim code; and use of different internal operational code representations of the required logical function.

20. A microprocessor comprising:
a processor comprising logic, a first subset of the logic comprising a first logic cloud and a second subset of the logic comprising a second logic cloud; and
a program memory comprising a base algorithm relating to the first logic cloud and a diverse algorithm generated from the base algorithm and information about the logic and relating to the second logic cloud.

21. The microprocessor of claim 20, further comprising:
a data memory comprising a variable storage portion for information relating to the base algorithm and a diverse variable storage portion for information relating to the diverse algorithm.

22. The microprocessor of claim 20, wherein the first and second logic clouds are at least partially indistinct.

23. The microprocessor of claim 20, wherein the diverse algorithm comprises an automatically generated diverse algorithm.

24. The microprocessor of claim 20, wherein the base algorithm comprises a manually generated base algorithm.

25. A method comprising:
manually creating a base algorithm implementation associated with a first hardware channel of an array of hardware channels;
automatically generating a diverse algorithm implementation associated with a second hardware channel of the array of hardware channels using the base algorithm implementation; and
executing the base algorithm implementation and the diverse algorithm implementation using the first hardware channel and the second hardware channel, respectively.
